(19) United States
(12) Patent Application Publication
(10) Pub. No.: US 2016/0241607 A1
(43) Pub. Date: Aug. 18, 2016

(54) REVERSE SIGNALING TO ESTABLISH NETWORK CALLS

(71) Applicant: Voxofon, Houston, TX (US)

(72) Inventors: Alexey Goloshubin, Houston, TX (US); Julia Goloshubina, Houston, TX (US)

(73) Assignee: Voxofon

(21) Appl. No.: 14/625,554

(22) Filed: Feb. 18, 2015

(51) Int. Cl. H04L 29/06

(52) U.S. Cl. CPC H04L 65/1069; H04L 65/1076; H04L 65/1006

(57) ABSTRACT

Reverse signaling to establish network calls. An example method of reverse signaling to establish network calls includes contacting an app server by a first device with a request to call a second device. The example method also includes contacting a push service by the app server, and the push service contacting the second device with the request to call the second device. The example method also includes sending an invite to a call server by the second device, the call server sending the invite to the first device. The example method also includes sending an acknowledgement to the call server from the first device, the call server sending the acknowledgement to the second device to establish the call.

### BACKGROUND

Voice over Internet Protocol (VoIP) is a methodology which delivers communication signals (e.g., voice and multimedia) over networks such as the Internet, rather than via a public switched telephone network (PSTN). The steps involved in originating VoIP calls are similar to traditional digital telephony and involve signaling, channel setup, digitization of analog voice signals, and encoding. Instead of being transmitted over a circuit-switched network, however, the digital information is packetized, and transmission occurs as packets over a packet-switched network.

VoIP calling systems typically have two main network components—signaling and media. For example, a VoIP system may use Session Initiation Protocol (SIP) for signaling (e.g., the setup protocol), and Realtime Transport Protocol (RTP) for exchanging real-time media streams (e.g., audio streams, video, screen sharing, etc.). If a caller wants to setup a call to a recipient, both devices have to be connected to a signaling server (SIP Server). That is, the calling device has to be connected to the SIP server and maintain a connection, and the called device also has to be connected to the SIP server and maintain a connection.

VoIP transmission entails careful considerations about resource management. These solutions work well for desktop and laptop computers with always-on, often “unlimited” (e.g., very high) bandwidth Internet connections and unrestricted power usage. However when taken in the mobile context this causes problems. For the devices to be reachable from the signaling server, they must maintain open active network connections to the server. This puts unnecessary stress on the battery life of the mobile device, and requires constant use of an often limited bandwidth Internet connection on the mobile device.

### BRIEF DESCRIPTION OF THE DRAWINGS

FIG. 1 is a block diagram of an example network system which may be implemented to establish network calls.

FIGS. 2-6 are high-level illustrations of signaling to establish network calls.

FIGS. 7 and 8 are flowcharts illustrating example operations to establish network calls.

FIG. 9 is a flowchart illustrating other example operations to establish network calls.

### DETAILED DESCRIPTION

Signaling systems and methods to signaling to establish network calls are disclosed. An example method includes contacting an app server by a first device with a request to call a second device. The example method also includes contacting a push service by the app server, and the push service contacting the second device with the request to call the second device. The example method also includes sending an invite to a call server by the second device, the call server sending the invite to the first device. The example method also includes sending an acknowledgement to the call server from the first device, the call server sending the acknowledgement to the second device to establish the call.

It can be seen that the call setup implements a mobile push operation, and the direction of he messages during the main signaling protocol are “reversed” relative to a traditional SIP protocol. Accordingly, the techniques described herein may be referred to as “reverse signaling.”

For purposes of illustration, consider a SIP signaling environment. Both Device A (caller or calling device) and Device B (called device) are registered with the App server. If Device A wants to call Device B, then Device A informs the app server that it wants to call Device B. The app server sends the mobile push service a push message with the address of Device B. The mobile push service delivers the message to Device B. Device B sends a SIP Invite message to the SIP Server. The SIP server sends the SIP Invite message to Device A. Device A accepts the call, and sends a SIP ACK to the SIP server. The SIP server sends the SIP ACK to Device B. A connection is established and media streaming can commence between Device A and Device B

Consider another illustration, this time in a WebRTC environment. Both Device A and Device B are registered with the App server. If Device A wants to call Device B, then Device A sends a mobile push message for call setup to Device B using a mobile push channel. Device B sends an “Offer” message to the signaling server which forwards it to Device A using a signaling channel. Device A in turn sends an “Answer” message using the signaling channel.

In both of these illustrations, neither of the devices have to maintain a persistent network connection to the call server (or the App server). Instead, after registering, the devices can be disconnected until the time of the call. At that time, the calling device contacts the App server, and call setup commences. Accordingly, battery life and bandwidth consumption are significantly reduced, making this technique particularly applicable, although not limited in use, to mobile devices.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the terms “push” (e.g., “push services” and “push notifications”) means providing a communication channel in an efficient manner which enables sending of information from one device to another (e.g., a server to a client). The protocols may include by way of example, but are not limited to, proprietary protocols such as the Apple Corporation iOS Push Notification Service, the Google Corporation Cloud Messaging, and/or other proprietary or standardized protocols now known or later developed whether the term “push” is used or simply provides the same or similar functionality.

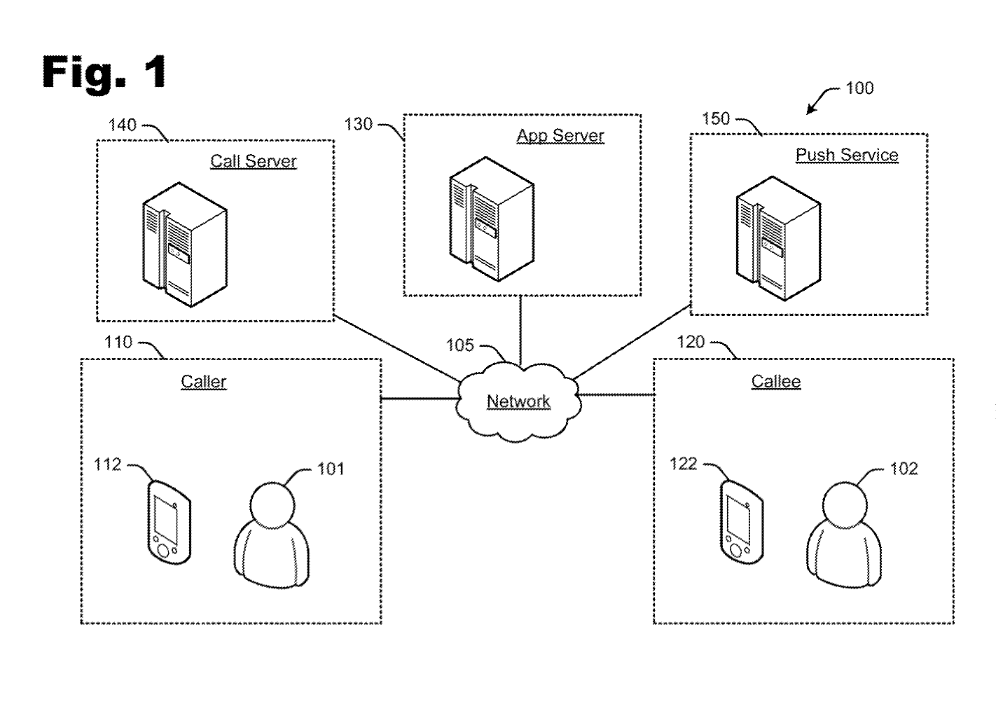

FIG. 1 is a block diagram of an example network system which may be implemented to establish network calls. System 100 may be a network call environment, such as VoIP operable with any number of call participants.

Call participants are generally referred to in FIG. 1 as caller 110 and callee 120. The caller 110 may include a person 101 using a caller device 112, and the callee 120 may include a person 102 using a called device 122. It is noted that the terms “caller” device and “called” device are used herein for purposes of clarity, but these terms are not intended to be limiting. For example, a device 112 may be a calling device and another device 122 may be a called device in an example call setup. For another call, the same device 112 may be the called device and the other device 122 may be the calling device. Likewise, the system 100 is not limited to any number of devices, and may include conference calls among a plurality of devices, wherein there are more than one caller and/or callee.

The call devices 112 and 122 may be any suitable computing device, capable of accessing the network 105 to establish a communications connection (e.g., voice, video, screen sharing, etc.), referred to herein generally as a call. The call devices 112 and 122 are not limited to any particular type of devices.

Communication network 105 may be any suitable network which provides accessibility to other devices in distributed environments. Suitable networks may include a local area network (LAN) and/or wide area network (WAN). To illustrate, the network 105 may be the Internet or other mobile communications network (e.g., a 3G or 4G mobile device network).

In an example, the call devices 112 and 122 may be implemented with a wide variety of computing devices, such as, but not limited to, mobile devices (e.g., mobile phones, tablets). However, the system 100 is not limited to a mobile device environment. For example, the system 100 may also be implemented with stand-alone desktop/laptop/netbook computers, workstations, and appliances (e.g., devices dedicated to providing a service), to name only a few examples. The computing devices described herein may be provided on the network 105 via a communication connection, such as via an Internet service provider (ISP).

In an example, the system 100 may include an app server 130 and a call server 140. It is noted that the app server 130 and call server 140 may be implemented as separate devices and/or as a single device configured to provide the distinct functionality of the app server and call server, as described herein. The app server 130 and call server 140 are each configured with program code to establish a call.

In an example, the app server 130 is accessed by the call devices 112 and 122 for registration and call setup. The app server 130 may also be operatively associated with a push service 150 (which may be provided as part of the app server 130 or as a separate entity).

In an example, the call server 140 is accessed by the call devices 112 and 122 during call setup, and to handle the call once it has been established. In an example, the call server 140 may be configured as a SIP server. In another example, the call server 140 may be configured as a WebRTC server. Still other configurations now known or later developed, are contemplated herein as will become readily apparent to those having ordinary skill in the art after becoming familiar with the teachings herein.

It is noted that each of the servers 130, 140 may be configured as a server computer with processor(s) and computer-readable storage. Example services provided by the servers 130, 140, in addition to the call handling services described herein, may include general purpose computing services. Services may be provided via application programming interfaces (APIs) and related support infrastructure.

Each of the computing devices (e.g., call devices 112, 122 and servers 130, 140) may include memory, storage, and a degree of data processing capability at least sufficient to manage a communications connection either directly with one another or indirectly (e.g., via a network). The computing devices may also be configured with sufficient processing capability to execute the respective program code described herein.

Before continuing, it is noted that the computing devices (e.g., call devices 112, 122 and servers 130, 140) are not limited in function. The computing devices may also provide other services in the system 100. For example, the computing devices may also provide general transaction processing services.

It is also noted that the terms “App Server” and “Call Server” and other devices/components referred to herein, do not need to be embodied in separate devices, and may be embodied within the same physical machine while maintaining separate logical functions.

Each of the computing devices may be configured with program code. In an example, the program code may be implemented in machine-readable instructions (such as but not limited to, software or firmware). The machine-readable instructions may be stored on a non-transient computer readable medium and are executable by one or more processor. When executed by a processor, the instructions program the computing device as a special machine which performs the operations described herein.

In an example, the program code executes the function of the machine readable instructions as self-contained modules. These modules can be integrated within a self-standing tool, or may be implemented as agents that run on top of an existing program code. It is noted, however, that this description of program code is provided only for purposes of illustration of an example operating environment, and are not intended to limit implementation to any particular system.

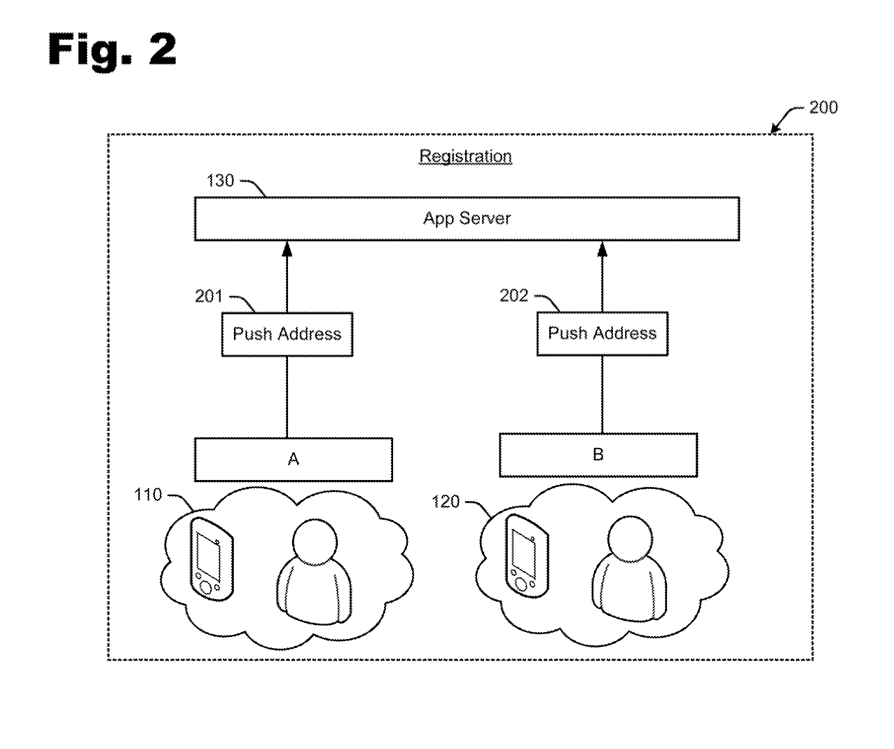

FIGS. 2-6 are high-level illustrations of signaling to establish network calls. In this example, the call devices A and B are considered to be mobile devices, each including a mobile operating OS that has a mobile push system that allows delivering messages to the device even when the push applications are not running. In the following illustration, call device B is not running the push application, and therefore is not maintaining an active Internet connection to the app server 130 or the call server 140. It is noted, however, that the same process would also work if device B happens to have an active connection with the call server, however it is not necessary that device B maintain an active connection in order for this process to operate as described below. As such, device B can effectively manage network connections/bandwidth and power/battery life.

FIG. 2 is an illustration of an example registration process 200. During the registration process 200, a call device A registers with an app server 130. In addition, at least one other call device B registers with the app server 130. Any number of call devices may register with the app server 130. As such, any call device registered with the app server 130 may initial a call to any other call device registered with the app server 130. Registration may include the call devices A and B sending their respective push addresses 201, 202 to the app server 130.

It is noted that the app server 130 may be the same app server. In an example, however, the app server 130 may be physically distributed in a network environment such that there is more than one app server. In such an example, the physically distributed app servers communicate with one another and/or a central database, such that registration information is shared between each app server.

It is also noted that the registration process need only occur one time for each device. Although the registration process may be repeated (e.g., if the device is reset and/or otherwise obtains a different push address), typically multiple calls can be made to/from the call devices A and B with only a single registration.

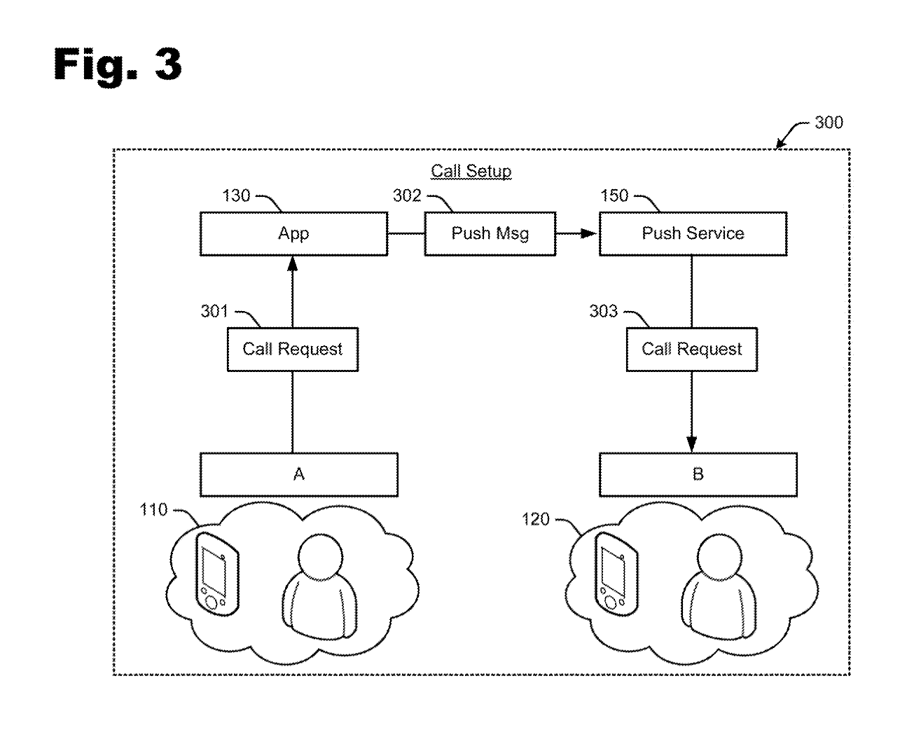

FIG. 3 is an illustration of an example part of a call setup process 300. During the part of call setup process 300, the call device A contacts the app server 130. For example, the call device A may send the app server a message (or “call request”) 301 identifying another call device B. The app server 130 contacts the push service 150. For example, the app server 130 may send the push service 150 a push message 302 with the push address of the call device B. It is noted that the address of the called device is available to the app server 130 as a result of registration described in FIG. 2 above. The message may also include the call request from call device A.

The push service 150 in turn contacts the call device B. For example, the push service may deliver the call request 303 from the app service 130, or generate a new message. In any event, the message 303 indicates that the call device A is attempting to establish a call with call device B.

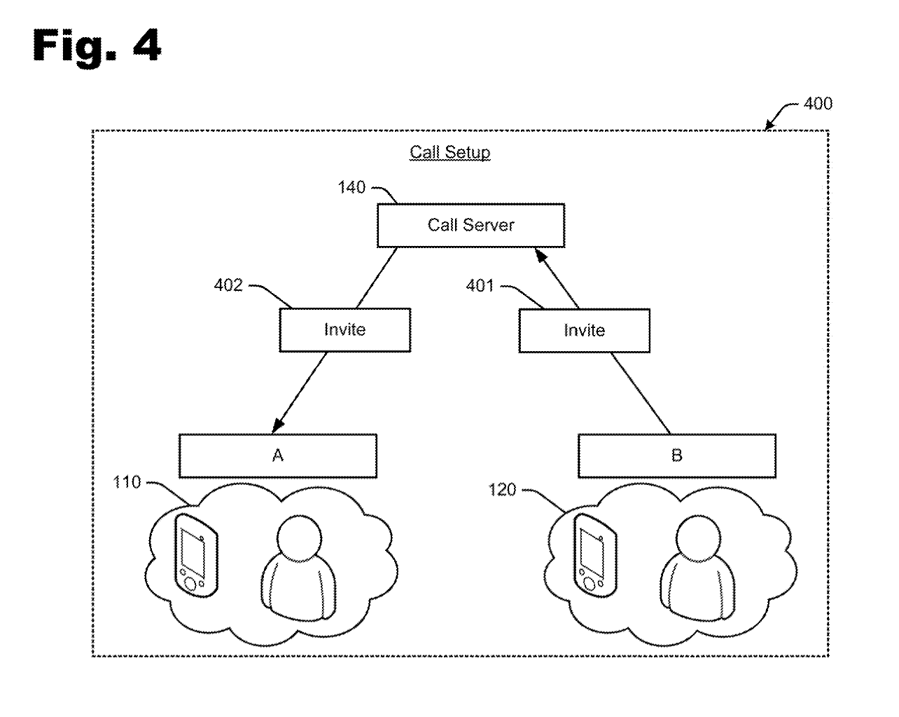

It is noted that the call device B may be unavailable or decline the call request. In an example, the call device A receives a message indicating that the call device B is unavailable or has otherwise declined the call. If the call device B accepts the call, then operations may continue as illustrated in FIG. 4.

FIG. 4 is an illustration of an example another part of a call setup process 400. During the part of call setup process 400, the call device B sends an invite 401 to a call server 140. In an example where the call server 140 is a SIP server, the invite may be a SIP Invite message. In another example where the call server is a WebRTC signaling server, the invite may be an Offer message.

The call server 140 sends the invite 402 to call device A. For example, the call server 140 may forward the invite from call device B, or generate a new invite. In any event, the invite 402 indicates that call device B is available for the call with call device A.

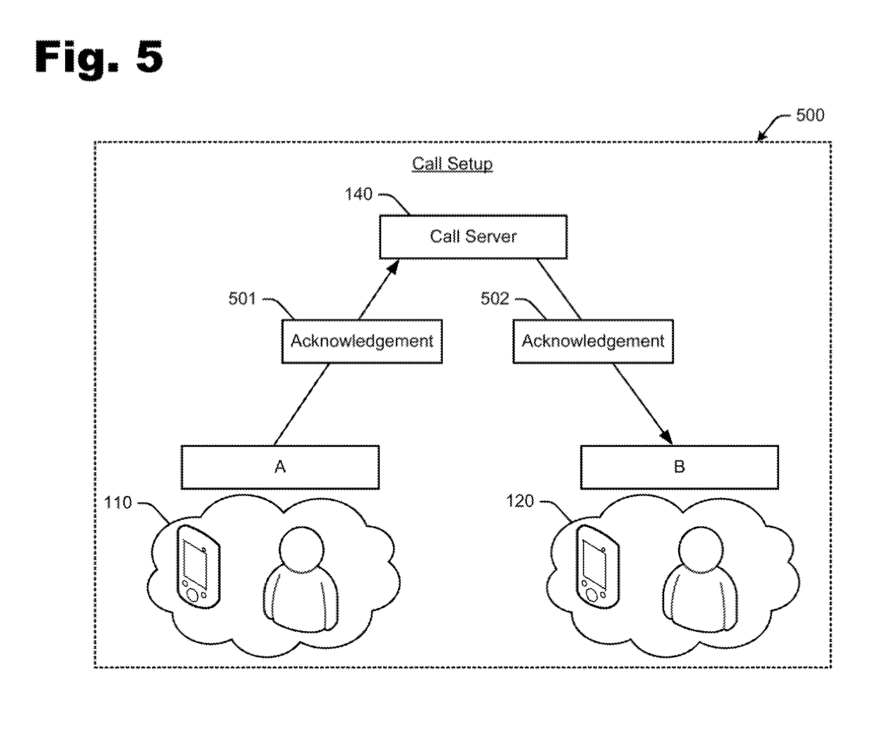

FIG. 5 is an illustration of an example another part of a call setup process 500. During the part of call setup process 500, the call device A sends an acknowledgment 501 to a call server 140. In an example where the call server 140 is a SIP server, the acknowledgement 501 may be a SIP ACK. In another example where the call server is a WebRTC signaling server, the acknowledgement 501 may be an “Answer” signal.

The call server 140 sends the acknowledgement 502 to call device A. For example, the call server 140 may forward the acknowledgement from call device A, or generate a new acknowledgement. In any event, the acknowledgement 502 indicates that call device A is available for the call with call device B.

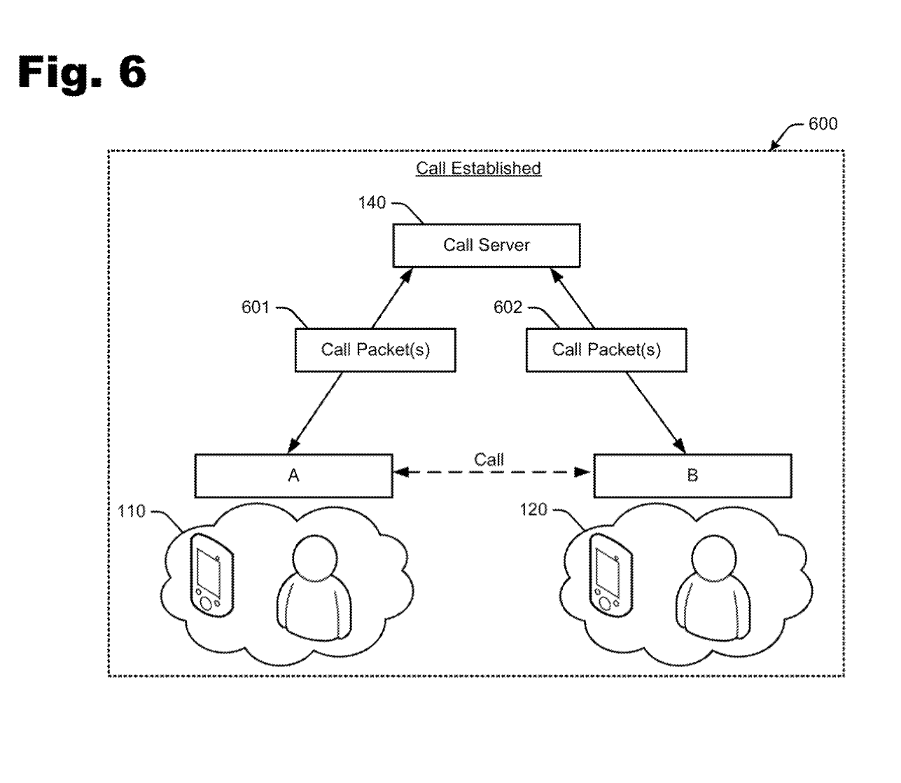

FIG. 6 is an illustration of an example call process 600. At this point, the call setup process has successfully established a call 605 between call device A and call device B. The call may continue until at least one of call device A and call device B terminates the call (e.g., by the user hanging up). The call may include issuing data packets 601 and 602 between the devices, e.g., via the call server 140. In an example, the call may be a VoIP session. It is noted that the call may include any suitable communications data, such as but not limited to voice, video, and/or other media.

It is noted that the call devices do not have to maintain a persistent network connection to the servers (e.g., the call server or the App server). Instead, after registering, the call devices can be disconnected until the time of the call. At that time, the calling device contacts the App server, and call setup commences. Communications connections with the servers are only established on an as-needed basis. Between calls, a network connection is not needed (at least for purposes of being available for a call), and the device can enter a low-power (e.g., “sleep”) state. Accordingly, battery life and bandwidth consumption are significantly reduced, making this technique particularly applicable, although not limited in use, to mobile devices.

Before continuing, it should be noted that the examples described above are provided for purposes of illustration, and are not intended to be limiting. Other devices and/or device configurations may be utilized to carry out the operations described herein.

It is further noted that SIP specific terminology is used to describe example call operations for purposes of illustration. However, the techniques described herein are not limited to the SIP technology. For example, other signaling protocols may also be implemented.

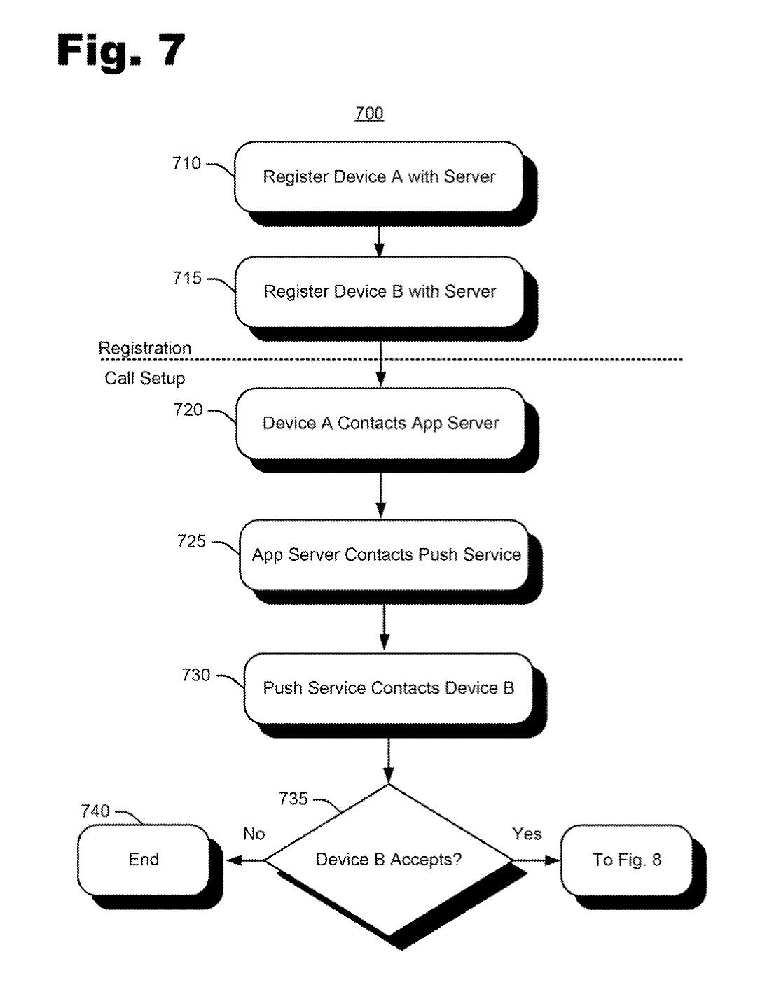

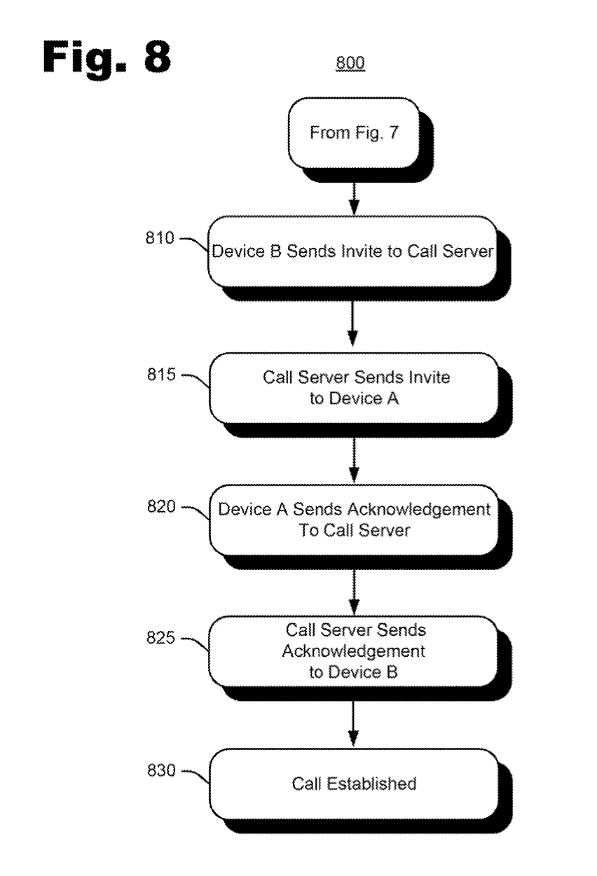

FIGS. 7 and 8 are flowcharts illustrating example operations to establish network calls. Operations 700 and 800 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

In an example, operations 710 and 715 in FIG. 7 may be considered registration operations; and the remaining operations in FIGS. 7 and 8 may be considered call setup operations.

In FIG. 7, operation 710 includes a calling device registering with an app server. Operation 715 includes a called device registering with an app server. It is noted that the terms “calling” device and “called device” are used for purposes of clarity and are not intended to be limiting. For example, a device (e.g., Device A) may be a calling device and another device (e.g., Device B) may be a called device in an example call setup; and another time the same device (e.g., Device A) may be the called device and another device (e.g., Device B) may be the calling device. Likewise, the operations described herein are not limited to any number of devices. For example, Devices A-n may be implemented, wherein Device n is any device and may be a calling device and/or a called device.

Operation 720 includes the calling device contacting the app server. For example, the calling device may send the app server a message identifying a called device (e.g., a device that the calling device is calling, even though the device has not yet been called).

In operation 725, the app server contacts a push service. For example, the app server may send the push service a push message with the address of the called device. It is noted that the address of the called device is available to the app server as a result of the registration operation 715. The message may also include the request from the calling device.

In operation 730, the push service contacts the called device. For example, the push service may deliver the message from the app service, or generate a new message, indicating that the calling device is attempting to establish a call with the called device.

In operation 735, the called device may be unavailable or decline the call request, at which point operations may end at 740. In an example, the calling device receives a message indicating that the called device is unavailable or has otherwise declined the call. If the called device accepts the call, then operations 800 illustrated in FIG. 8 may commence.

In operation 810, the called device sends an invite to a call server. In an example, the invite may be a SIP Invite message where the call server is a SIP server. In another example, the invite may be an Offer message where the call server is a WebRTC signaling server.

In operation 815, the call server sends the invite to the calling device In operation 820, the calling device sends an acknowledgement (ACK) to the call server. It is noted that in an example where the call server is a WebRTC signaling server, the ACK may be referred to as an “Answer” signal. In operation 825, the call server sends the ACK to the called device. And in operation 830, a call is established.

The operations shown and described herein are provided to illustrate example implementations. It is noted that the operations are not limited to the ordering shown. Still other operations may also be implemented. For example, a call may be retried when at first a called device is unavailable. Or for example, the calling device may be notified when the called device is not registered with the app server.

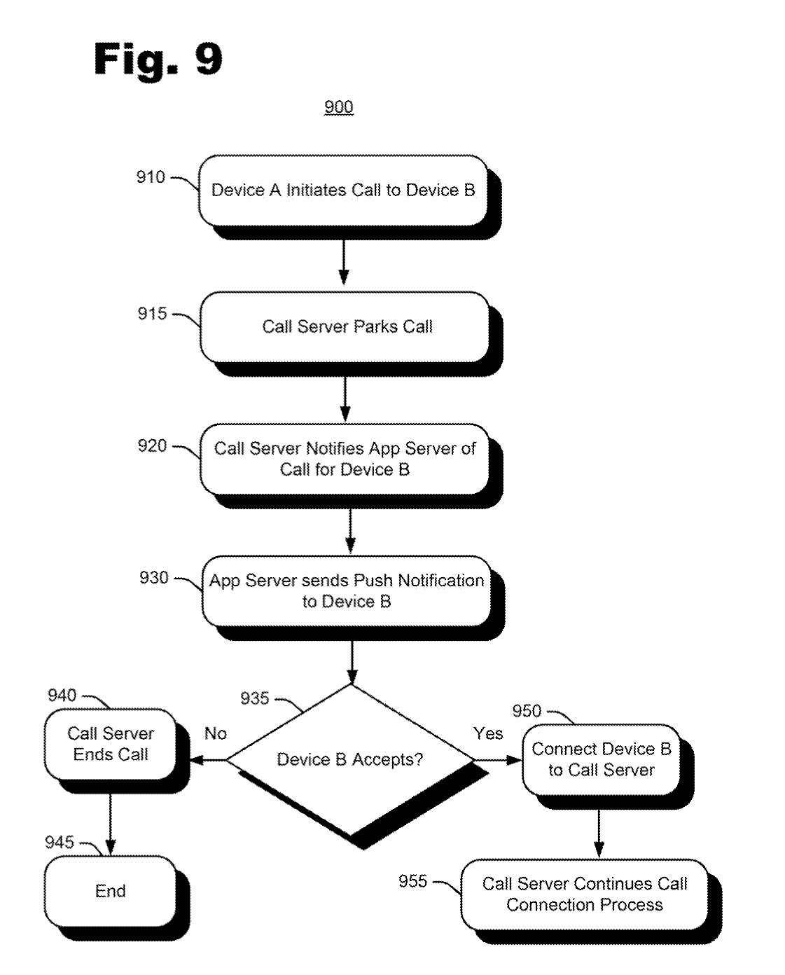

FIG. 9 is a flowchart illustrating other example operations to establish network calls. Again, operations 900 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

Again, the devices (e.g., Device A and Device B) first register their respective push addresses with an app server. In an example, operation 910 includes Device A initiating a call to Device B. This call may be initiated, by way of illustration, via a VoIP/WebRTC calling procedure. For example, Device A may send a SIP Invite to a call server.

In operation 915, the call server parks the call. For example, call server does not send the call to Device B, enabling the call to proceed even if Device B is not connected to the call server.

In operation 920, the call server notifies the app server of the incoming call for Device B. In operation 930, the app server sends a push notification notifying Device B of the incoming call.

If Device B rejects the call in operation 935, then the call server ends the call from Device A in operation 940 and operations end at 945. If Device B accepts the call in operation 935, then Device B is connected to the call server in operation 950. The call server continues with the call connection process in operation 955. For example, Device B may receive a SIP invite and respond so that the call server can bridge the call with Device A.

It is noted that the examples shown and described are provided for purposes of illustration and are not intended to be limiting. Still other examples are also contemplated.

1. A method of reverse signaling to establish network calls, comprising:
contacting an app server by a first device with a request to call a second device;
contacting a push service by the app server, and the push service contacting the second device with the request to call the second device;
sending an invite to a call server by the second device, the call server sending the invite to the first device; and
sending an acknowledgement to the call server from the first device, the call server sending the acknowledgement to the second device to establish the call.

2. The method of claim 1, further comprising registering the first device with the app server prior to contacting the app server with the request to call the second device.

3. The method of claim 2, wherein registering the first device with the app server is with a push address of the first device.

4. The method of claim 1, further comprising registering the second device with the app server prior to contacting the app server with the request to call the second device.

5. The method of claim 4, wherein registering the second device with the app server is with a push address of the second device.

6. The method of claim 1, wherein the second device only sends the invite to the call server if the second device accepts the request by the first device to call the second device.

7. A method to establish network calls, comprising:
parking a call from a first device to a second device by a call server;
notifying an app server of the call by the call server; and
connecting the second device to the first device if the second device accepts the call.

8. The method of claim 7, further comprising the first device and the second device registering respective push addresses with the app server.

9. The method of claim 7, further comprising the app server sending the second device a push notification of the call.

10. The method of claim 7, further comprising sending a SIP invite to the second device if the second device accepts the call, and after receiving a response to the SIP invite from the second device, the call server bridging the call between the first and second devices.

11. A system to establish network calls, comprising:
an app server configured to receive a call request from a first device;
a push service configured to receive a message from the app server, the push service contacting a second device with the call request upon receiving the message from the app server;
a call server configured to receive an invite from the second device and issue the invite to the first device, and the call server further configured to issue an acknowledgement from the first device to the second device to establish a call between the first device and the second device.

12. The system of claim 11, wherein the app device registers the first device prior to issuing the call request.

13. The system of claim 12, wherein the app server registers a push address of the first device.

14. The system of claim 11, wherein the app device registers the second device prior to issuing the call request.

15. The system of claim 14, wherein the app server registers a push address of the second device.

16. The system of claim 11, wherein the app server only issues the invite to the first device if the second device accepts the call request.

17. The system of claim 1 wherein the call server is a SIP server.

18. The system of claim 11 herein the call server is a WebRTC signaling server.

19. The system of claim 11, further comprising a VoIP call network.

20. The system of claim 11, wherein after establishing the call, the first device issues call packets to the second device.
